(19) United States
(12) Patent Application Publication
(10) Pub. No.: US 2021/0028662 A1
(43) Pub. Date: Jan. 28, 2021

(54) Electric Motor Rotor Having Non-Uniform Laminations

(71) Applicant: Ford Global Technologies, LLC, Dearborn, MI (US)

(72) Inventors: Chun Tang, Canton, MI (US); Franco Leonardi, Dearborn Heights, MI (US); Michael W. Degner, Novi, MI (US); Chuanbing Rong, Canton, MI (US)

(73) Assignee: Ford Global Technologies, LLC, Dearborn, MI (US)

(21) Appl. No.: 16/520,547

(22) Filed: Jul. 24, 2019

(51) Int. Cl. H02K 1/27

(52) U.S. Cl. CPC H02K 1/2766

(57) ABSTRACT

A rotor for a permanent magnet electric machine has a lamination stack formed from a plurality of laminations arranged in a stack defining a void having a magnet-receiving portion and at least one flux barrier portion contiguous therewith. A magnet is disposed in the magnet-receiving portion, and some but not all of the laminations forming the stack include a positioner projecting into the flux barrier portion such that the positioners form a series of spaced-apart shelves retaining the magnet within the magnet-receiving portion. The shelves are spaced apart from one another by one or more of the laminations having no positioner.

### TECHNICAL FIELD

This disclosure relates to the field of permanent magnet electric motors. More particularly, the disclosure pertains to a rotor for such a motor wherein the laminations have flux-barrier voids that are non-uniform in configuration to reduce flux leakage.

### BACKGROUND

The permanent magnet electric motor (PMEM) has characteristics making it appropriate for use as a traction motor and/or a motor/generator in an electrically-powered vehicle. One type of PMEM has a rotor made up of a series of thin layers of ferrous metal, commonly referred to as laminations, arranged parallel with one another to form a lamination stack. The laminations are identical to one another, and each has several circumferentially-spaced openings or holes formed therein. When the laminations are formed into the stack, the holes are aligned with one another to form axially-extending internal voids defined in the stack, each void being configured to receive a permanent magnet. Each void is oversized relative to the magnet, the extra volume adjacent to the magnet acting as a flux barrier that re-shapes or/or re-directs the magnetic flux passing through the rotor during operation of the motor.

During assembly of the rotor, after the magnet is inserted into the magnet void the remaining flux barrier void is commonly filled with non-conductive potting material such as epoxy resin which is poured or injected into the voids in a liquid state after the magnet is inserted. After hardening, the epoxy resin prevents any movement of the magnet away from its desired position within the void during motor operation.

To ensure that the magnet remains properly positioned and does not shift into the flux barrier section of the void, it is known for the laminations to include one or more positioning tabs or “stoppers” which contact the magnet surfaces facing toward the flux barrier voids. The stoppers extend into and occupy what would otherwise be part of the flux barrier voids, which necessarily disrupts the desired/designed flux pattern of the motor, thus impairing the motor's efficiency and performance.

### SUMMARY OF THE DISCLOSURE

In a disclosed embodiment, a rotor for an electric machine comprises a plurality of laminations arranged in a stack defining a void having a magnet-receiving portion and at least one flux barrier portion contiguous therewith, and a magnet disposed in the magnet-receiving portion. Some but not all of the laminations include a positioner projecting into the flux barrier portion such that the positioners form a series of spaced-apart shelves retaining the magnet within the magnet-receiving portion. The shelves are spaced apart from one another by one or more of the laminations having no positioner.

The void defined in the stack may further have a second flux barrier portion contiguous with the magnet-receiving portion on a side thereof opposite from the flux barrier portion, and the laminations that include the positioner may further include a second positioner projecting into the flux barrier portions.

The stack may define a plurality of voids each comprising a magnet-receiving portion and a flux barrier portion contiguous therewith.

In a further disclosed embodiment, a lamination stack of a rotor of an electric machine comprises a plurality of first laminations and a plurality of second laminations arranged in an interspersed or interleaved fashion with one another. Each first lamination defines therein a hole comprising a magnet-receiving section and a flux barrier section contiguous with the magnet-receiving section, the flux barrier sections having a first configuration producing a first degree of flux leakage during operation of the electric machine. The second laminations each define therein a hole comprising a magnet-receiving section and a flux barrier section contiguous with the magnet-receiving section, the flux barrier sections of the second laminations having a second configuration different from the first configuration and producing a second degree of flux leakage during operation of the electric machine greater than the first degree of flux leakage. The lamination stack is formed by interspersing the first and second laminations with one another such that at least one of the first laminations is located between an axially-proximate pair of the second laminations.

Each of the second laminations may comprise a positioner forming a physical barrier between the magnet-receiving section and the flux barrier section to obstruct movement of a magnet positioned in the magnet-receiving section toward the flux barrier section.

The hole of each of the second laminations may further have a second flux barrier section contiguous with the magnet-receiving section on a side thereof opposite from the flux barrier section, and the second laminations may each comprise a second positioner projecting into the second flux barrier section.

In a further disclosed embodiment, a lamination stack of a rotor of an electric machine comprises a plurality of positioning laminations and a plurality of plain laminations arranged in an interspersed or interleaved fashion with one another. Each positioning lamination defines therein a hole comprising a magnet-receiving section and at least one flux barrier section contiguous with the magnet-receiving section, the flux barrier section having a perimeter configured to obstruct movement of a magnet positioned in the magnet-receiving section of the hole toward the flux barrier sections of the hole. Each of the plain laminations defines therein a hole comprising a magnet-receiving section and a flux barrier section contiguous with the magnet-receiving section, the flux barrier section having a perimeter configured to present no obstruction to movement of a magnet positioned in the magnet-receiving section toward the flux barrier section. Plain and positioning laminations are interspersed or interleaved with one another so that at least one of the plain laminations is located between an axially-proximate pair of the positioning laminations.

The positioning laminations may each comprise a positioner forming a physical barrier between the magnet-receiving section and the flux barrier section to obstruct movement of a magnet positioned in the magnet-receiving section toward the flux barrier section.

The hole of each of the positioning laminations may further have a second flux barrier section contiguous with the magnet-receiving section on a side thereof opposite from the flux barrier section, and the positioning laminations may each comprise a second positioner projecting into the second flux barrier section.

### BRIEF DESCRIPTION OF THE DRAWINGS

FIG. 1 is a schematic perspective view of a lamination stack for the rotor of a permanent magnet electrical machine.

FIG. 2 is an enlarged view of the area indicated in FIG. 1.

FIG. 3 is an enlarged view of the area indicated in FIG. 2.

FIG. 4 is a top/planar view of a portion of a plain lamination as used in the stack shown in FIGS. 1-3.

FIG. 5 is a top/planar view of a portion of a positioning lamination as used in the stack shown in FIGS. 1-3.

FIG. 6 is a perspective view of a portion of the second disclosed embodiment of an improved lamination stack.

FIG. 7 is a top/planar view of a portion of a positioning lamination of the second disclosed embodiment.

FIG. 8 is a schematic perspective view of a magnet used in lamination stack shown in FIGS. 6 and 7.

FIG. 9 is a perspective view of a portion of a third disclosed embodiment of an improved lamination stack

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

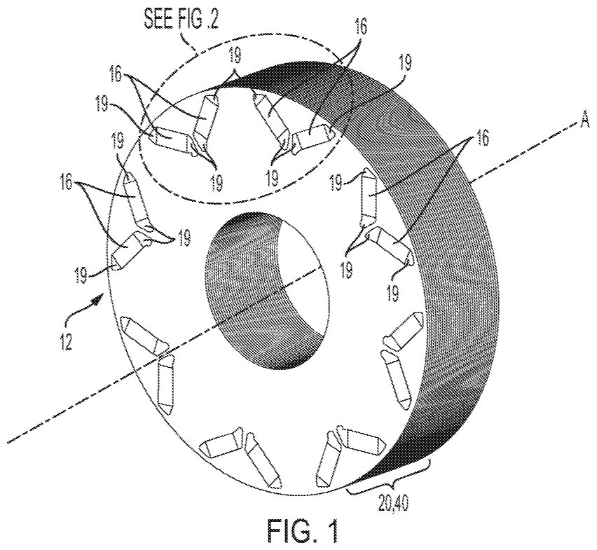

FIGS. 1 through 3 show a lamination stack 12 for use in a permanent magnet electric motor. Stack 12 is generally toroidal and is supported by a central shaft or spindle (not shown) which defines an axis A about which it rotates when it is assembled as part of the motor and the motor is electrically energized. Stack 12 comprises a plurality of laminations 20, 40 that are arranged in planar contact with one another. Laminations 20, 40 have holes formed therein that align with one another when stacked to form voids 18 defined by and within the stack 12. A plurality of permanent magnets 16 are received in a corresponding number of voids 18.

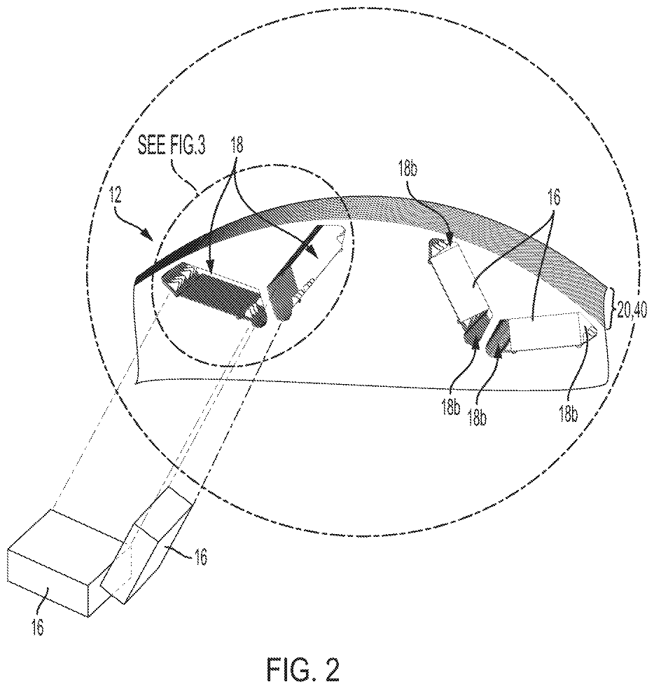

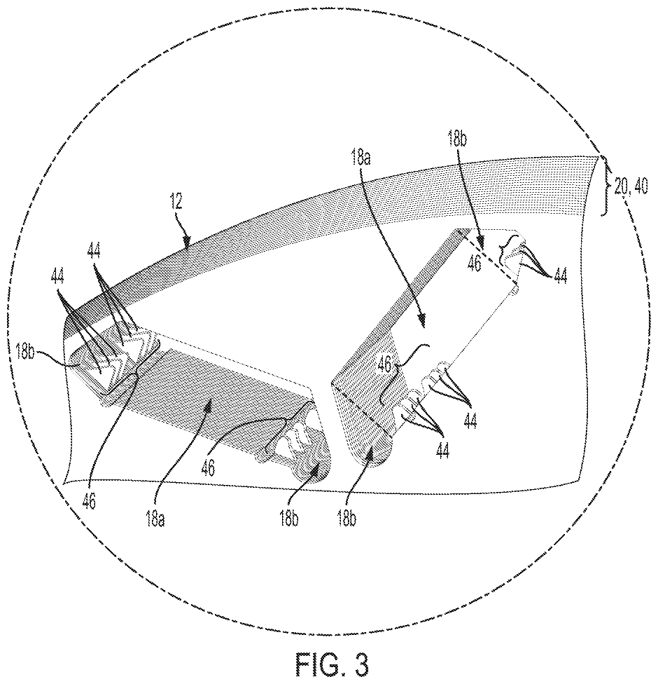

Each void 18 is larger in volume than its respective magnet 16, and the extra volume adjacent to either end of the magnet is filled with a potting material 19, such as epoxy resin. The potting material is omitted from FIGS. 2 and 3 in order to clearly show the interior surfaces of the voids 18.

As best seen in FIGS. 2 and 3, each void 18 comprises a central magnet-receiving portion 18a into which a magnet 16 fits when the rotor is assembled and at least one flux barrier portion 18b contiguous with the magnet-receiving portion. In the depicted embodiment, magnet-receiving portions 18a are rectangular in cross section to match that of the magnets 16. In FIG. 3, dashed lines indicate the boundaries between magnet-receiving portion 18a and flux barrier portion 18b of the void 18 on the right side of the drawing. In a conventionally-known rotor design, a flux barrier portion 18b is typically present at each opposite end of a magnet-receiving portion 18a as shown. As is known in the art, the two flux barrier portions 18b contiguous with a magnet-receiving portion 18a may be identical in configuration to one another or they may be of different configurations. The configuration of a particular flux barrier void in a particular motor design depends on numerous design parameters of the motor, and the configurations shown and described herein are only by way of example and should not to be construed as limiting the invention in any way.

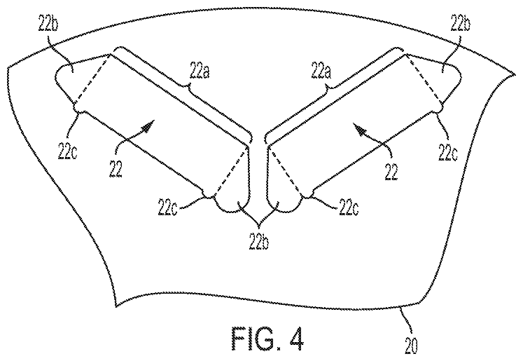

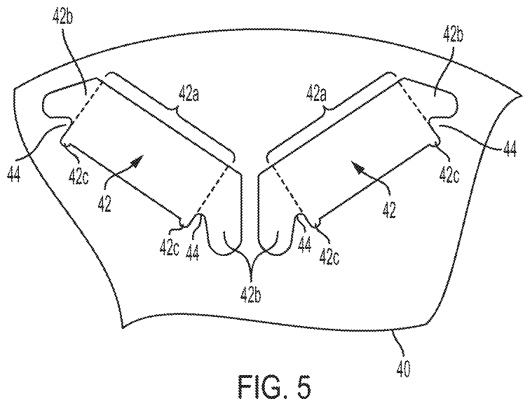

The laminations that make up stack 12 are of two different types: Plain laminations 20 (FIG. 4); and positioning laminations 40 (FIG. 5). Both types of laminations 20, 40 are formed of ferrous metal and have generally identical outer contours so that the outer circumferential surface of stack 12 is uniform in shape. For a motor of the general size and type used as a traction motor in a road vehicle, each of the laminations 20, 40 may be of a thickness on the order between 0.2 and 0.5 mm. Plain laminations 20 and positioning laminations 40 are distinguished from one another by the configurations of the holes formed therein, as explained below.

Plain laminations 20 (see FIG. 4) are configured to define a plurality of holes 22 that, when the laminations are arranged in planar contact as part of stack 12, are in alignment with one another to form the respective voids 18 defined axially (extending parallel with rotational axis A) within the stack. Each hole 22 is made up of a central magnet-receiving section 22a and two flux barrier sections 22b, one at either end of the magnet-receiving section and contiguous therewith. When laminations 20 are included in a stack 12, magnet-receiving sections 22a contribute to formation of magnet-receiving portion 18a and flux barrier sections 22b contribute to formation of respective flux barrier portions 18b.

Magnet-receiving section 22a has a configuration matching the cross-sectional configuration of magnet 16. Flux barrier sections 22b are conventionally located adjacent to opposite ends of the magnet-receiving section 22a and have respective configurations designed (as is well known in the art) to reduce magnetic flux leakage, and hence elevate the torque production of the resulting stack 12. The two flux barrier sections 22b of each hole 22 may be configured differently from one another, as shown. The configuration of a particular flux barrier section in a particular motor design depends on numerous design parameters of the motor, and the configurations shown and described herein are only by way of example and should not to be construed as limiting the invention in any way.

Positioning laminations 40 (see FIG. 5) are configured to define a plurality of holes 42 therein that, when the laminations are arranged in series as part of stack 12, are aligned with one another and with holes 22 to contribute to formation of axially-extending voids 18. Each hole 42 is made up of a central magnet-receiving section 42a and two flux barrier sections 42b contiguous therewith. Holes 42 may further comprise stress reliefs 42c located as necessary to avoid sharp corners in the hole geometry that may cause stress concentrations.

As shown in FIG. 4, the holes 22 of plain laminations 20 may also include semi-circular portions 20c matching the location and geometry of stress reliefs 42c in order to permit potting material to entirely fill the voids 18 during manufacture of the stack 12.

Central magnet-receiving sections 42a are substantially identical to respective magnet-receiving sections 22a of plain laminations 20.

Positioning laminations 40 differ in configuration from plain laminations 20 in that positioning laminations have at least one positioner 44 not present in the plain laminations. Therefore, the flux barrier section 42b adjacent to and partially defined by the positioner 44 differs in configuration from its corresponding flux barrier section 22b of a plain (positioner-free) lamination.

Positioner 44 projects into a flux barrier section 42b and thereby defines a portion of the perimeter of said flux barrier section immediately adjacent to magnet-receiving section 42a. Positioner 44 forms a physical barrier between the magnet-receiving section and the flux barrier section. The perimeter of the flux barrier section 42b is, due to the presence of positioner 44, configured to obstruct movement of magnet 16 away from the magnet-receiving section 42a of the void and toward the flux barrier section 42b.

As best seen in FIG. 3, lamination stack 12 includes a combination of plain laminations 20 and positioning laminations 40 interspersed or interleaved with one another. At least one plain lamination 20 is located between each axially-adjacent pair of positioning laminations 40 so that positioners 44 form a series of spaced-apart shelves 46 projecting into the flux barrier portions 18b. Shelves 46 are located and configured to contact magnet 16 and prevent movement of magnet out of the magnet-receiving portion 18a. The shelves 46 formed by positioners 44 are spaced apart by the total thickness of the number of plain (positioner-free) laminations 20 located therebetween. At least one but preferably more than one plain lamination 20 is located between each axially-adjacent pair of shelves 46. In the depicted embodiment, each axially-adjacent pair of positioning laminations 40 is separated by an equal number of plain laminations. interspersing the first and second laminations with one another such that at least one of the first laminations is located between an axially-proximate pair of the second laminations

A lamination stack 12 that includes positioning laminations 40 interspersed with plain laminations 20 will have an axially-extending (extending parallel with rotational axis A) void 18 defined in part by holes 42, and therefore positioners 44 will project into the void in a manner to obstruct movement of a magnet 16 located in the magnet-receiving section 18a toward the flux barrier section 18b.

Prior art rotors of permanent magnet electric motors are known to comprise a lamination stack made up only of positioning laminations. Every lamination of the stack includes a positioner made of ferrous material which projects into the flux barrier portion, and therefore every lamination produces or results in a certain degree of flux leakage in the stack, resulting in the degradation of the torque production capability.

Because the disclosed plain lamination 20 has no ferrous positioner projecting into its flux barrier section 22b, it produces or results in a degree of flux leakage smaller than the degree of flux leakage produced by a positioning lamination 40. Therefore, when plain laminations 20 are included in a lamination stack 12, the number of projections and therefore the total amount of ferrous material projecting into the desired/designed flux barrier portion 18b is reduced in comparison with prior art rotor formed entirely from positioning laminations 40. This yields a corresponding lower leakage flux compared with the prior art lamination stack, and therefore improves demagnetization resistance for the magnets and overall motor efficiency and torque density.

In general, it is believed that best results will be achieved by a stack having the smallest number of positioners 44 that are still adequate to hold a magnet securely in its desired position. In the illustrated exemplary embodiment, four plain laminations 20 separate each axial-adjacent pair of positioning laminations 40. It is believed that this repeating pattern of positioning laminations interspersed with plain laminations provides secure retention of magnets 16 in the magnet-receiving portions 18a while providing the advantages described below.

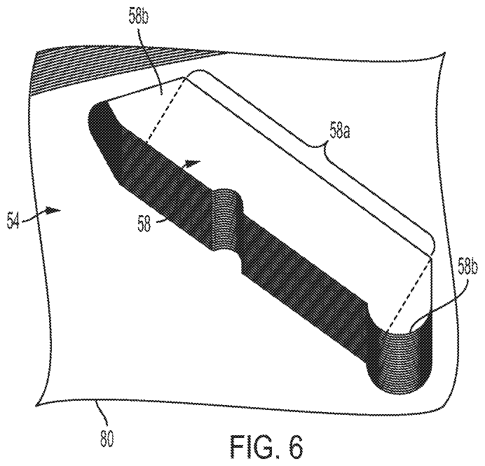

A second embodiment of a rotor of an electric machine is shown in FIGS. 6 through 8. Similar to the FIG. 1-5 embodiment described above, in this second embodiment a lamination stack 54 is made up of a plurality of laminations that are arranged in planar contact with one another so as to form a generally toroidal stack, and the laminations have holes formed therein that align with one another when stacked to form voids defined by and within the stack for receiving magnets.

As seen in FIG. 6, lamination stack 54 defines at least one void 58 comprising a central magnet-receiving portion 58a and at least one flux barrier portion 58b contiguous with the magnet-receiving portion. Dashed lines delineate the border between magnet-receiving portion 58a and flux barrier portions 58b. The two flux barrier portions 58b associated with a magnet-receiving portion 58a may be identical in configuration to one another or they may be of different configurations.

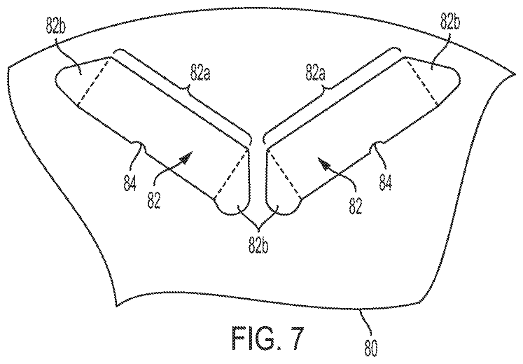

Stack 54 is formed entirely of positioning laminations 80 (see FIG. 7) which are configured to define a plurality of holes 82 therein such that, when the laminations are arranged in series, are aligned with one another to contribute to formation of axially-extending voids 58.

Positioning laminations 80 have at least one positioner 84 projecting inward from a side of the magnet-receiving section 82a such that it impinges on magnet-receiving section 82a. In distinction from the positioning laminations 40 of the first embodiment disclosed herein, positioners 84 are located on and project from a side of a perimeter of magnet-receiving section 82a that is not contiguous with a flux barrier portion. Positioner 84 projects inward toward magnet-receiving section 82a and thereby defines a portion of the perimeter of said magnet-receiving section.

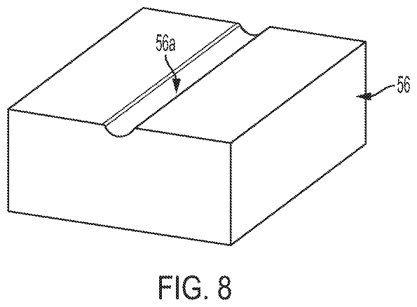

Magnet 56 (FIG. 8) which fits into void 58 has a groove 56a extending along its axial direction and is shaped complementally to positioner 84 so that the positioner engages the groove when the magnet is inserted axially into void 58. Due to the presence of positioner 84, the perimeter of the magnet-receiving section 82a is configured to obstruct movement of magnet 56 away from the magnet-receiving portion 58a of the void and toward either of the flux barrier portions 58b.

Because positioners 84 do not project from a perimeter of flux barrier portions 82b nor intrude into flux barrier sections 80b, no ferrous material at all intrudes into flux barrier portions 58b. This results in a lower leakage flux compared with prior art rotors, and therefore the torque production is improved.

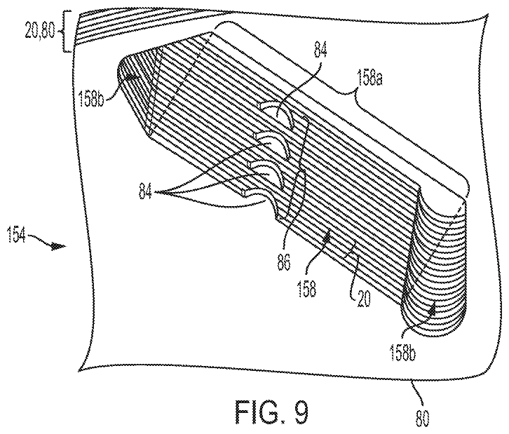

In a third embodiment of a lamination stack shown in FIG. 9, the laminations that make up a stack 154 are of two different types that are interleaved with one another: positioning laminations 80 and plain laminations 20 (that are substantially identical to that shown in FIG. 4). When plain laminations 20 and positioning laminations 80 are arranged in planar contact as part of stack 154, the respective hole 22 and 82 are in alignment with one another to form the respective voids 158 defined axially within the stack.

In the depicted embodiment, the only pertinent difference between plain laminations 20 and positioning laminations 80 is that the plain laminations are absent a positioner 84 and therefore magnet-receiving section 22a has a configuration that does not exactly match the cross-sectional configuration of magnet 56.

A lamination stack 154 that includes positioning laminations 80 interspersed with plain laminations 20 will have an axially-extending void 158 defined in part by holes 82, and therefore positioners 84 will project into the void and serve to obstruct movement of a magnet 56 located in the magnet-receiving portion 158a of the void. Because at least one plain lamination 20 is located between an axially-adjacent pair of positioning laminations 80, the positioners 84 form a series of axially spaced-apart shelves 86 projecting into the magnet-receiving portions 158a, the shelves of the series 86 engaging groove 56a and preventing movement of magnet out of the magnet-receiving portion 158a. The shelves of the series 86 formed by positioners 84 are spaced apart by the total thickness of the number of plain laminations 20 located therebetween. At least one but preferably more than one plain lamination 20 is located between each axially-proximate pair of shelves 86.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A rotor for an electric machine comprising:
a plurality of laminations arranged in a stack defining a void having a magnet-receiving portion and at least one flux barrier portion contiguous therewith; and
a magnet disposed in the magnet-receiving portion, wherein some but not all of the laminations include a positioner projecting into the flux barrier portion such that the positioners form a series of spaced-apart shelves retaining the magnet within the magnet-receiving portion, the shelves spaced apart from one another by one or more of the laminations having no positioner.

2. The rotor of claim 1, wherein each axially-adjacent pair of the laminations that include the positioner is separated by an equal number of laminations having no positioner.

3. The rotor of claim 1, wherein at least two of the laminations having no positioner are between an axially-adjacent pair of shelves.

4. The rotor of claim 1, wherein the void further has a second flux barrier portion contiguous with the magnet-receiving portion on a side thereof opposite from the flux barrier portion, and the laminations that include the positioner further include a second positioner projecting into the flux barrier portions.

5. The rotor of claim 1, wherein the stack defines a plurality of voids each comprising a magnet-receiving portion and a flux barrier portion contiguous therewith.

6. The rotor of claim 1, wherein the magnet-receiving portion is rectangular in cross section.

7. A lamination stack of a rotor of an electric machine comprising:
a plurality of first laminations, each defining therein a hole comprising a magnet-receiving section and a flux barrier section contiguous with the magnet-receiving section, the flux barrier sections having a first configuration producing a first degree of flux leakage during operation of the electric machine; and
a plurality of second laminations each defining therein a hole comprising a magnet-receiving section and a flux barrier section contiguous with the magnet-receiving section, the flux barrier sections of the second laminations having a second configuration different from the first configuration and producing a second degree of flux leakage during operation of the electric machine greater than the first degree of flux leakage, wherein the lamination stack is formed by interspersing the first and second laminations with one another such that at least one of the first laminations is located between an axially-proximate pair of the second laminations.

8. The lamination stack of claim 7, wherein the second laminations each comprise a positioner forming a physical barrier between the magnet-receiving section and the flux barrier section to obstruct movement of a magnet positioned in the magnet-receiving section toward the flux barrier section.

9. The lamination stack of claim 8, wherein each axially-adjacent pair of the second laminations is separated by an equal number of the first laminations.

10. The lamination stack of claim 8, wherein at least two of the first laminations are between an axially-adjacent pair of the second laminations.

11. The lamination stack of claim 8, wherein the hole of each of the second laminations further has a second flux barrier section contiguous with the magnet-receiving section on a side thereof opposite from the flux barrier section, and the second laminations each comprise a second positioner projecting into the second flux barrier section.

12. The lamination stack of claim 7, wherein the magnet-receiving sections of the first and the second laminations are rectangular in cross section.

13. A lamination stack of a rotor of an electric machine comprising:
a plurality of positioning laminations each defining therein a hole comprising a magnet-receiving section and at least one flux barrier section contiguous with the magnet-receiving section, the flux barrier section having a perimeter configured to obstruct movement of a magnet positioned in the magnet-receiving section of the hole toward the flux barrier sections of the hole; and
a plurality of plain laminations each defining therein a hole comprising a magnet-receiving section and a flux barrier section contiguous with the magnet-receiving section, the flux barrier section having a perimeter configured to present no obstruction to movement of a magnet positioned in the magnet-receiving section toward the flux barrier section, at least one of the plain laminations being located between an axially-proximate pair of the positioning laminations.

14. The lamination stack of claim 13, wherein the positioning laminations each comprise a positioner forming a physical barrier between the magnet-receiving section and the flux barrier section to obstruct movement of a magnet positioned in the magnet-receiving section toward the flux barrier section.

15. The lamination stack of claim 13, wherein each axially-adjacent pair of the positioning laminations is separated by an equal number of the plain laminations.

16. The lamination stack of claim 13, wherein at least two of the plain laminations are between an axially-adjacent pair of the positioning laminations.

17. The lamination stack of claim 13, wherein the hole of each of the positioning laminations further has a second flux barrier section contiguous with the magnet-receiving section on a side thereof opposite from the flux barrier section, and the positioning laminations each comprise a second positioner projecting into the second flux barrier section.

18. The lamination stack of claim 13, wherein the magnet-receiving sections of the plain laminations and the positioning laminations are rectangular in cross section.
